(19) United States
(12) Patent Application Publication
(10) Pub. No.: US 2015/0121766 A1
(43) Pub. Date: May 7, 2015

(54) SAFETY DOOR

(71) Applicant: Tae Young Jeong, Guri-si (KR)

(72) Inventor: Tae Young Jeong, Guri-si (KR)

(21) Appl. No.: 14/394,737

(22) PCT Filed: Jan. 9, 2013
(86) PCT No.: PCT/KR2013/000159

§ 371 Date: Oct. 15, 2014

(30) Foreign Application Priority Data
Sep. 10, 2012 (KR) 10-2012-0099813

(51) Int. Cl. E06B 7/36; E06B 5/10

(52) U.S. Cl. CPC E06B 7/362; E06B 5/10; E06B 7/36; E06B 7/367; E06B 2007/365
USPC 49/462

(57) ABSTRACT

The present invention provide a safety door including a corner portion having a plurality of hinges coupled thereto in a vertical direction, the corner portion being at one side of a door opened/closed as the door rotates in a horizontal direction, and a door post having a safety groove formed therein in the vertical direction to insert a portion, or all, of the corner portion therein for preventing a portion of a user's body from being pressed by the corner portion.

### TECHNICAL FIELD

The present invention relates to a safety door, and more particularly, to a safety door for preventing a negligent accident from taking place due to a gap between a door post and a door.

### BACKGROUND ART

In general, the door provides a function of dividing a space from another space to form an independent space by using steel or wood.

In general, a steel door is arranged to an outer space for the purposes of a gate, such as an entrance, and burglar prevention, and a wooden door is arranged between a space and another space for dividing a room space.

In this case, the wooden door in a wall of the room space has a function of making selective closure of a space between a door frame with the door post and a threshold, and has a sliding door and a hinged door, typically.

However, because such related art doors, each having a structure in which the door post and the hinge are coupled for opening/closing the door, to form the gap between the door post and the door if the door is opened, and to form no gap if the door is closed, the related art door has a problem in that a portion of a user's body is liable to be jammed in the gap to cause a negligent accident.

### DISCLOSURE OF INVENTION

### Technical Problem

To solve the problems, an object of the present invention is to provide a safety door which can prevent a negligent accident from taking place due to a gap formed between a door post and a door.

### Technical Solution

To achieve these objects and other advantages and in accordance with the purpose of the invention, as embodied and broadly described herein, a safety door includes a corner portion having a plurality of hinges coupled thereto in a vertical direction, the corner portion being at one side of a door opened/closed as the door rotates in a horizontal direction, and a door post having a safety groove formed therein in the vertical direction to insert a portion, or all, of the corner portion therein for preventing a portion of a user's body from being pressed by the corner portion.

The door post may include a step formed to prevent a gap from forming between one side end portion of the door and the safety groove.

The step may be formed along a length direction of the door post and may include a sealing member for preventing foreign matter from infiltrating between the step and the one side end portion of the door.

The one side end portion of the door may be formed rounded for preventing noise and wear from taking place, and may include a supplementary member to be in contact with the sealing member.

The one side end portion of the door may be formed rounded for preventing noise and wear from taking place, and may include a projected piece formed to prevent a gap from forming between the safety groove and the door.

The safety groove may include a projected piece groove recessed inward in the safety groove in conformity with the projected piece.

The hinge may have one side coupled such that a portion, or all of, the one side of the hinge is disposed in the safety groove, and the other side coupled to the corner portion.

### Advantageous Effects

The safety door of the present invention has following advantageous effects.

First, since there is no gap between the door post and the door, the negligent accident in which a portion of a user's body is jammed therein can be prevented.

Second, the safety door is interchangeable with an existing door.

Third, the safety door is simple in construction and a construction period and cost can be reduced.

### BRIEF DESCRIPTION OF THE DRAWINGS

FIG. 1 illustrates a plan view of a safety door in accordance with a first preferred embodiment of the present invention.

FIG. 2 illustrates a plan view of the safety door in FIG. 1 in a rotated state.

FIG. 3 illustrates an enlarged partial view of the safety door in FIG. 1.

FIG. 4 illustrates a plan view of a safety door in accordance with a second preferred embodiment of the present invention.

FIG. 5 illustrates a plan view of the safety door in FIG. 4 in a rotated state.

FIG. 6 illustrates a plan view of a safety door in accordance with a third preferred embodiment of the present invention.

FIG. 7 illustrates a plan view of the safety door in FIG. 6 in a rotated state.

### BEST MODE

Reference will now be made in detail to the specific embodiments of the present invention, examples of which are illustrated in the accompanying drawings. In describing the specification, it is required that terms or words used in the specification and claims should not be interpreted limited to a conventional meaning or a meaning in a dictionary, and should be interpreted in a meaning and a concept meeting technical aspects of the present invention based on a principle that the inventor may define terms and concepts appropriately for describing the invention of the inventor in the best method.

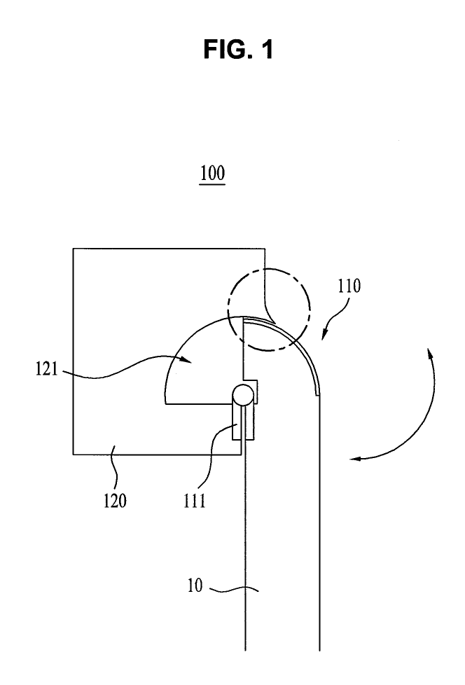

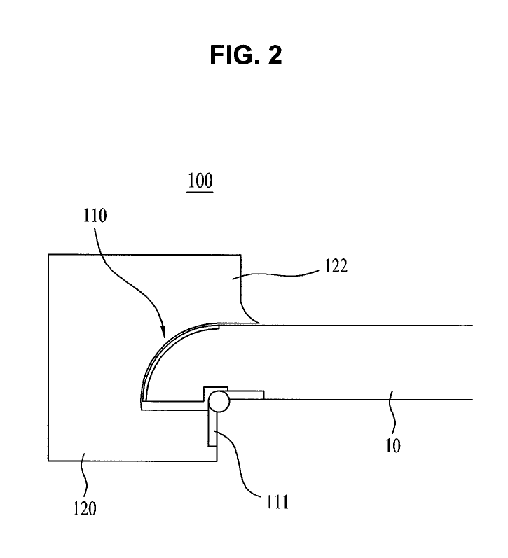

FIG. 1 illustrates a plan view of a safety door 100 in accordance with a first preferred embodiment of the present invention, and FIG. 2 illustrates a plan view of the safety door 100 in FIG. 1 in a rotated state.

Referring to FIGS. 1 and 2, the safety door 100 in accordance with a first preferred embodiment of the present invention includes a corner portion 110 formed at one side of a door 10 to have a hinge 111 coupled thereto, and a door post 120 having a safety groove 121 formed therein for inserting the corner portion 110 therein as the door 10 rotates.

The door post 120 is a kind of column posted on both sides of an inside of the wall in a vertical direction having one side the door 10 at one side thereof coupled thereto with the hinge 111.

The safety groove 121 formed in the door post 120 arranged in a vertical direction which is a length direction of the door post 120, and has a function of receiving one side end portion of the door 10 when the door 10 is opened.

Therefore, the one side end portion of the door 10 and the safety groove 121 are formed rounded in conformity with a rotation direction of the door 10 for preventing a portion of the user's body from being jammed to cause an external wound. Of course, the safety groove 121 may be formed, not only in a rounded arc shape, but also in a square shaped groove, or a polygonal shaped groove more than the square shaped groove as far as the shape does not interfere with rotation of the door 10.

With reference to the safety groove 121, the door post 120 has one side having the door 10 coupled thereto with the hinge 111, and the other side having a step 122 formed thereon projected beyond an extension line of a side of the door 10.

The step 122 has functions of preventing the gap from forming between the door post 120 and the door 10, as well as foreign matter from infiltrating between the door post 120 and the door 10.

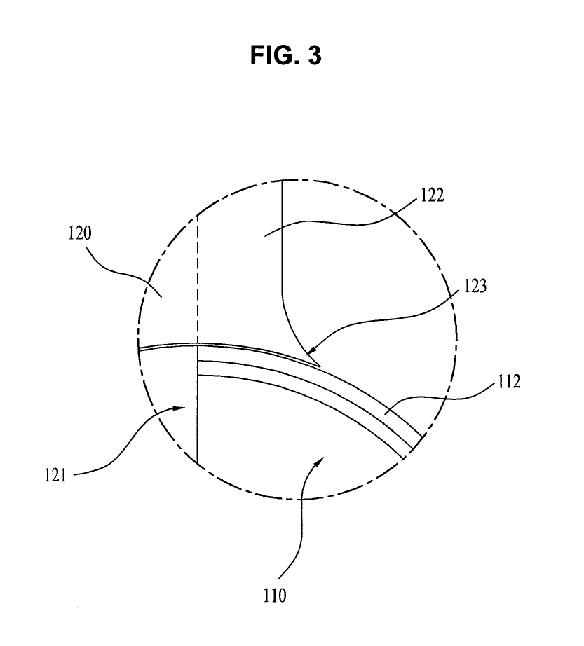

FIG. 3 illustrates an enlarged partial view of the safety door 100 in FIG. 1.

Referring to FIG. 3, the step 122 formed on the other side of the door post 120 has a sealing member 123 provided thereto formed to extend to a portion adjacent to the door 10.

And, a rounded portion of the door 10 on one side end portion thereof has a supplementary member 112 coupled thereto for reducing noise and increasing durability of the one side end portion of the door 10.

The sealing member 123 and the supplementary member 112 may be arranged to be in contact with each other, or to be spaced to maintain a least gap.

In this case, the sealing member 123 may be formed of a synthetic resin material or a silicone group rubber having elasticity.

The sealing member 123 makes the gap between the step 122 and the corner portion 110 to be smallest to cut an environment off from a source, in which a negligent accident takes place only by small gap, for an example, like a child's finger.

Even if the door is opening in a state a hand of a child of a user is positioned at the corner portion 110 or the step 122, the sealing member 123 may make the finger to move to an upper side of the step 122.

Moreover, the sealing member 123 has an effect of improving a closing performance between the safety groove 121 and the door 10.

The door 10 has the supplementary member 112 provided to the one side end portion, i.e., the rounded portion, of the door 10.

It is preferable that the supplementary member 112 is formed of steel or synthetic resin material having heat resistance, abrasion resistance, corrosion resistance and so on.

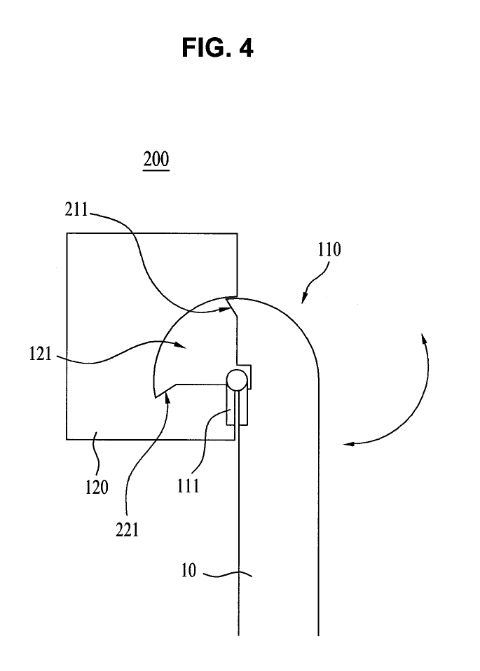

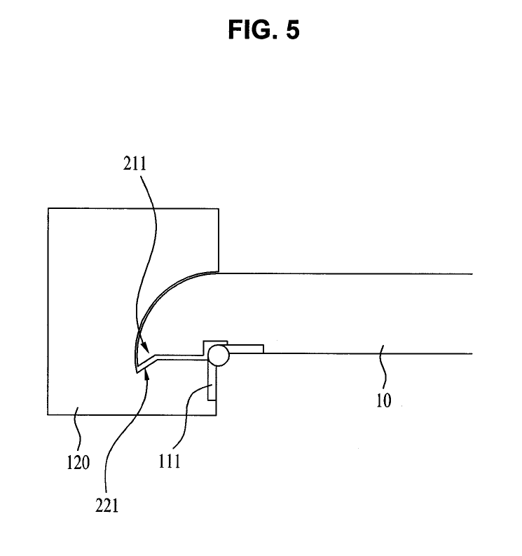

FIG. 4 illustrates a plan view of a safety door 200 in accordance with a second preferred embodiment of the present invention, and FIG. 5 illustrates a plan view of the safety door 200 in FIG. 4 in a rotated state. Hereinafter, the same reference numbers will be used to refer to the same parts.

Referring to FIGS. 4 and 5, the safety door 200 in accordance with a second preferred embodiment of the present invention includes a corner portion 110 formed at one side of the door 10 to have a hinge 111 coupled thereto, and a door post 120 having a safety groove 121 formed therein to insert the corner portion 110 therein as the door 10 rotates.

In this case, the corner portion 110 is formed rounded for enabling the corner portion 110 to be inserted in, and drawn out of, the safety groove. And, the door 10 has one side end portion with a projected piece 211 formed thereon such that a portion, or all, of the one side end portion of the door 10 is to be disposed in the safety groove 121 always.

It is preferable that the projected piece 211 is projected from the one side end portion of the door 10 formed rounded or tapered, to have the same radius with the rounded portion of the one side end portion of the door 10.

Moreover, besides a tapered shape, the projected piece 211 may have a variety of shapes, such as a polygonal shape or a semi-circular shape.

In this case, the safety groove 121 has a projected piece groove 221 formed therein in conformity with the shape of the projected piece 211 for inserting the projected piece 211 therein.

Then, it is possible to prevent a gap from forming between the door post 120 and the corner portion 110, enabling to prevent a negligent accident in which a portion of a user's body is jammed in the gap from taking place in advance, as well as foreign matter from infiltrating therein, permitting to extend a lifetime of the safety door 200.

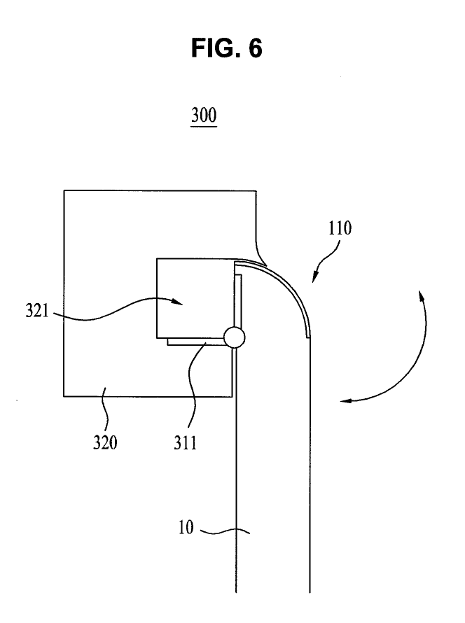

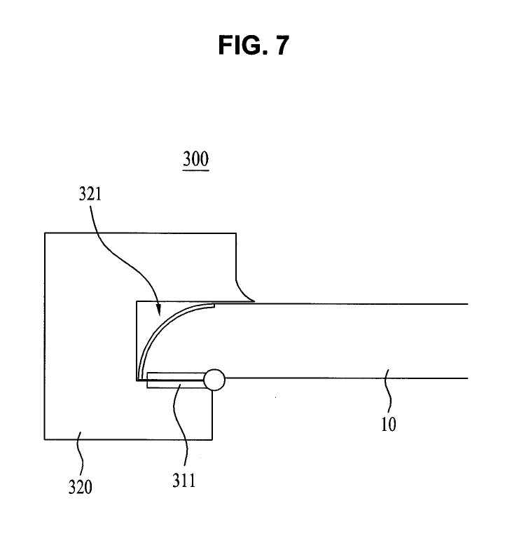

FIG. 6 illustrates a plan view of a safety door 300 in accordance with a third preferred embodiment of the present invention, and FIG. 7 illustrates a plan view of the safety door 300 in FIG. 6 in a rotated state. Hereinafter, the same reference numbers will be used to refer to the same parts.

Referring to FIGS. 6 and 7, the safety door 300 in accordance with a third preferred embodiment of the present invention has a safety groove 321 formed in a square shaped groove.

The safety groove 321 enables, not only easy processing on the door post 320, but also to expect an effect of reduction of a processing cost. And, it is apparent that the safety groove 321 may be formed to have, not only the square shape, but also a polygonal shape, a circular shape, or an elliptical shape within a range the shape of the safety groove 321 does not interfere with opening and closing of the door 10.

And, the hinge 311 coupled to the corner portion 110 of the door 10 is disposed in the safety groove 321.

In this case, the hinge 311 has one side coupled to an inside of the safety groove 321 such that a portion, or all, of the one side of the hinge 311 is to be disposed in the inside of the safety groove 321, and the other side coupled to the corner portion 110.

In that case, the hinge 311 has a portion visible from an outside of the door reduced significantly, enabling to provide an effect of displaying an elegant exterior appearance in opening and closing of the door 10.

Operation and advantages of the safety door of the present invention will be described with reference to the drawings, in detail. Hereinafter, the same reference numbers will be used to refer to the same parts.

Alike a general door, the safety door 100 of the present invention may be coupled with the hinge 111, easily.

The door post 120 has the safety groove 121 formed in a back side of a portion of the door post 120 the hinge 111 is to be coupled thereto such that the corner portion 110 may be introduced thereto.

By providing a function of preventing the gap from forming between the corner portion 110 and the door post 120 as the door 10 rotates, the safety groove 121 may prevent a portion of the user's body from being jammed.

Moreover, the sealing member 123 provided to the door post 120 cuts off infiltration of foreign matter, such as dust, into the safety groove 121, thereby improving durability of the safety door 100.

Moreover, the supplementary member 112, provided to the corner portion 110 disposed to be in contact with, or adjacent very close to the sealing member 123, has functions of covering an inside of the safety groove 121 and prevention of negligent accident from taking place, together with the sealing member 123.

And, the supplementary member 112 prevents the door 10 mostly formed of wood from making direct friction with the sealing member 123, thereby doubling durability of the corner portion 110.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The safety door of the present invention is applicable to a hinged door having various structures and shapes, because the safety door is improved to have a structure in which the gap produced between the door and the door post inevitably is invisible from an outside of the door and enhanced constructability and easy exchangeability.

1. A safety door comprising:
a corner portion having a plurality of hinges coupled thereto in a vertical direction, the corner portion being at one side of a door opened/closed as the door rotates in a horizontal direction; and
a door post having a safety groove formed therein in the vertical direction to insert a portion, or all, of the corner portion therein for preventing a portion of a user's body from being pressed by the corner portion.

2. The safety door as claimed in claim 1, wherein the door post includes a step formed to prevent a gap from forming between one side end portion of the door and the safety groove.

3. The safety door as claimed in claim 2, wherein the step is formed along a length direction of the door post and includes a sealing member for preventing foreign matter from infiltrating between the step and the one side end portion of the door.

4. The safety door as claimed in claim 3, wherein the one side end portion of the door is formed rounded for preventing noise and wear from taking place, and includes a supplementary member to be in contact with the sealing member.

5. The safety door as claimed in claim 1, wherein the one side end portion of the door is formed rounded for preventing noise and wear from taking place, and includes a projected piece formed to prevent a gap from forming between the safety groove and the door.

6. The safety door as claimed in claim 5, wherein the safety groove includes a projected piece groove recessed inward in the safety groove in conformity with the projected piece.

7. The safety door as claimed in claim 1, wherein the hinge has one side coupled such that a portion, or all of, the one side of the hinge is disposed in the safety groove, and the other side coupled to the corner portion.
